(19) United States
(12) Patent Application Publication
(10) Pub. No.: US 2016/0240160 A1
(43) Pub. Date: Aug. 18, 2016

(54) ELECTRO-OPTICAL DEVICE, DRIVING METHOD OF ELECTRO-OPTICAL DEVICE, AND ELECTRONIC APPARATUS

(71) Applicant: SEIKO EPSON CORPORATION, Shinjuku-ku, Tokyo (JP)

(72) Inventor: Akihiko ITO, Suwa-shi (JP)

(21) Appl. No.: 15/030,025

(22) PCT Filed: Oct. 15, 2014
(86) PCT No.: PCT/JP2014/005232

§ 371 Date: Apr. 15, 2016

(30) Foreign Application Priority Data
Oct. 17, 2013 (JP) 2013-216313

(51) Int. Cl. G09G 3/36; G09G 3/20

(52) U.S. Cl. CPC G09G 3/3677; G09G 3/2007; G09G 3/3614; G09G 2300/0426; G09G 2310/0251; G09G 2320/0214; G09G 2320/0233

(57) ABSTRACT

An electro-optical device includes a control circuit in which, when a selection signal (S1) is output, a corresponding first signal line is selected. When a selection signal (S2) is output during an output period of the selection signal (S1), a corresponding second signal line is selected. The control circuit outputs a selection signal so that an overlapping period occurs at a partial selection period of the first and second signal lines. Similarly, the control circuit outputs a selection signal so that an overlapping period occurs at a partial selection period of the second signal line corresponding to the selection signal (S2) and the third signal line corresponding to the selection signal (S3), or at a partial selection period of the third signal line corresponding to the selection signal (S3) and the fourth signal line corresponding to the selection signal (S4).

### TECHNICAL FIELD

The present invention relates to an electro-optical device such as a liquid crystal device, for example, a driving method of the electro-optical device, and a technical field of an electronic apparatus such as a liquid crystal projector, for example, which is configured of the electro-optical device.

### BACKGROUND ART

In a high resolution display which is referred to as 2K1K, since an influence of a transverse electric field which occurs between pixels is high, and it is not possible to adopt an H-line inversion driving system in which a polarity of a pixel electrode potential is inverted in each one line of pixel, a frame inversion driving system in which a polarity of a pixel electrode potential is inversed in each frame is adopted. In a general frame inversion driving system, a frame frequency of 60 Hz is used, however, when the frame frequency of 60 Hz is used in the high resolution display which is referred to as 2K1K, an influence of a flicker becomes high. Therefore, in the high resolution display which is referred to as 2K1K, double speed driving of which a frame frequency is 120 Hz is adopted.

However, when the double speed driving is adopted, there is a problem in that a selection period of one signal line becomes short, a problem occurs in writing of a display data signal with respect to a pixel, and an image quality deteriorates. Therefore, in the related art, the selection time is set not to be short, for example, by using four or six driving ICs, and by driving two or three driving ICs by sharing the ICs in both the horizontal direction and the vertical direction (for example, refer to PTL 1, PTL 2, and PTL 3).

### CITATION LIST

### Patent Literature

PTL 1: JP-A-2012-194326
PTL 2: JP-A-2000-242194
PTL 3: JP-A-2009-168849

### SUMMARY OF INVENTION

### Technical Problem

However, when four or six driving ICs are used, there is a problem in that a manufacturing cost increases. In addition, when the four or six driving ICs are used, it is necessary to perform wiring of two signal lines per one pixel row, and a structure of the pixel becomes complicated. When the driving IC is not increased, there is a problem in that a selection period of one signal line becomes short, a trouble occurs in writing of a display data signal with respect to a pixel, and an image quality deteriorates.

It is an object of the invention to provide an electro-optical device which can prevent deterioration of an image without making a pixel structure complicated, and without increasing a manufacturing cost, a driving method of the electro-optical device, and an electronic apparatus which includes the electro-optical device.

### Solution to Problem

According to an aspect of the invention, in order to solve the object, there is provided an electro-optical device which includes a plurality of scanning lines; a plurality of signal lines; a pixel which is provided so as to correspond to each intersection of the plurality of scanning lines and the plurality of signal lines; a scanning line driving unit which supplies a scanning signal to a scanning line; a signal line driving unit which supplies an image signal in which a data voltage with at least a size which corresponds to a grayscale to be displayed is subjected to time division multiplexing to the pixel through the signal line; a signal line selection unit which selects the signal line which supplies the image signal according to a control signal; and a control unit which selects another signal line while selecting one of the signal lines, and outputs the control signal so that an overlapping period occurs at a part of the selection period of the signal line, in which the pixel includes a pixel electrode, a common electrode, a liquid crystal which is interposed between the pixel electrode and the common electrode, and a switching element which is provided between the pixel electrode and the signal line, and is controlled so as to be either an ON state or an OFF state based on a scanning signal which is supplied through the scanning line.

According to the aspect, a scanning signal is supplied to a scanning line using a scanning line driving unit, and an image signal of which a data voltage with at least a size corresponding to a grayscale to be displayed is subjected to time division multiplexing is supplied to a pixel through the signal line. At this time, the signal line which supplies an image signal is selected using the signal line selection unit according to a control signal, however, in the control unit, another signal line is selected while one signal line is selected, and the control signal is output so that an overlapping period occurs at a part of the selection period of the signal line. Accordingly, it is possible to sufficiently secure a writing time of the data voltage with respect to a pixel, and to improve an image quality, since the overlapping period occurs at a part of the selection period of the signal line for writing the data voltage, even when the writing period of the data voltage per pixel becomes short due to high resolution.

In the electro-optical device, the control unit may output the control signal which selects the signal line at timing earlier than timing which is synchronized with an individual data voltage of the image signal which is subjected to time division multiplexing. According to the aspect, it is possible to sufficiently secure a writing time of the data voltage with respect to a pixel, and to improve an image quality.

In the electro-optical device, the signal line driving unit may supply a precharge voltage to the signal line at least in a precharge period before supplying the data voltage to the pixel, and the control unit may output the control signal which selects all of the signal lines in the precharge period. According to the aspect, it is possible to prevent uneven luminance, or a vertical cross talk by preventing an influence of leaking from a pixel.

In the electro-optical device, the scanning line driving unit may supply the scanning signal which causes the switching element to be in ON state to the scanning line in the precharge period. According to the aspect, it is possible to prevent uneven luminance, or a vertical cross talk by preventing the influence of leaking from the pixel.

In the electro-optical device, the signal line driving unit may output the control signal which selects the signal line which is firstly selected, in the entire period of the precharge period and the selection period of the signal line which is firstly selected in one horizontal scanning period. According to the aspect, it is possible to prevent uneven luminance, or a vertical cross talk by preventing the influence of leaking from the pixel due to writing of the precharge voltage with respect to the signal line, to sufficiently secure writing time of a data voltage with respect to a pixel, and to improve an image quality.

In the electro-optical device, the signal line driving unit may frequently change selection order of the signal line using the control signal. According to the aspect, it is possible to make an influence on a pixel corresponding to a signal line which is selected later uniform, using a data voltage of a pixel corresponding to a signal line which is selected in advance, among signal lines which are selected during the overlapping period.

According to another aspect of the invention, there is provided a control method of an electro-optical device which includes a plurality of scanning lines, a plurality of signal lines, a pixel which is provided so as to correspond to each intersection of the plurality of scanning lines and the plurality of signal lines, in which the pixel includes a pixel electrode, a common electrode, a liquid crystal which is interposed between the pixel electrode and the common electrode, and a switching element which is provided between the pixel electrode and the signal line, and is controlled so as to be in either ON state or OFF state based on a scanning signal which is supplied through the scanning line, the method including supplying the scanning signal to the scanning line; supplying an image signal in which a data voltage with at least a size which corresponds to a grayscale to be displayed is subjected to time division multiplexing to the pixel through the signal line; selecting the signal line which supplies the image signal according to a control signal; selecting another signal line while selecting one of the signal lines; and outputting the control signal so that an overlapping period occurs at a part of a selection period of the signal line.

According to still another aspect of the invention, there is provided an electronic apparatus which includes the electro-optical device according to the aspect of the invention. Such an electronic apparatus can sufficiently secure a writing time of a data voltage with respect to a pixel, and to improve an image quality in a display device such as a liquid crystal display since an overlapping period occurs at a part of a selection period of a signal line for writing a data voltage, even when the writing time of the data voltage per pixel becomes short due to high resolution.

### BRIEF DESCRIPTION OF DRAWINGS

FIG. 1 is an explanatory diagram of an electro-optical device according to a first embodiment of the invention.

FIG. 2 is a block diagram which illustrates a configuration of the electro-optical device according to the embodiment.

FIG. 3 is a circuit diagram which illustrates a configuration of pixels.

FIG. 4 is a timing chart which illustrates operations of the electro-optical device according to the embodiment.

FIG. 5 is a timing chart which illustrates operations of an electro-optical device according to a second embodiment of the invention.

FIG. 6 is a timing chart which illustrates operations of an electro-optical device according to a third embodiment of the invention.

FIG. 7 is a timing chart which illustrates operations of an electro-optical device according to a modification example.

FIG. 8 is a timing chart which illustrates operations of an electro-optical device in the related art.

FIG. 9 is an explanatory diagram which illustrates an example of an electronic apparatus.

FIG. 10 is an explanatory diagram which illustrates another example of the electronic apparatus.

FIG. 11 is an explanatory diagram which illustrates another example of the electronic apparatus.

### DESCRIPTION OF EMBODIMENTS

### First Embodiment

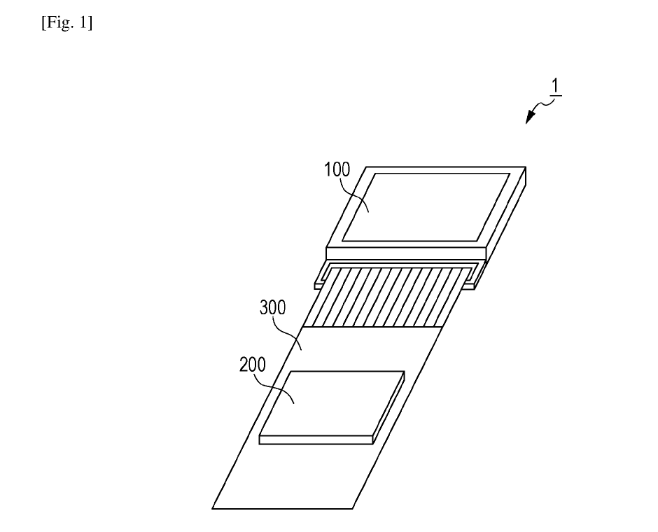

FIG. 1 is a diagram which illustrates a configuration of a signal transmission system with respect to an electro-optical device 1. As illustrated in FIG. 1, the electro-optical device 1 includes an electro-optical panel 100, a driving integrated circuit 200, and a flexible circuit board 300, and the electro-optical panel 100 is connected to the flexible circuit board 300 on which the driving integrated circuit 200 is mounted. The electro-optical panel 100 is connected to a host CPU (not illustrated) through the flexible circuit board 300 from the host CPU, and the driving integrated circuit 200. Here, the driving integrated circuit 200 is a unit which receives an image signal, and various control signals for controlling driving through the flexible circuit board 300, and drives the electro-optical panel 100 through the flexible circuit board 300.

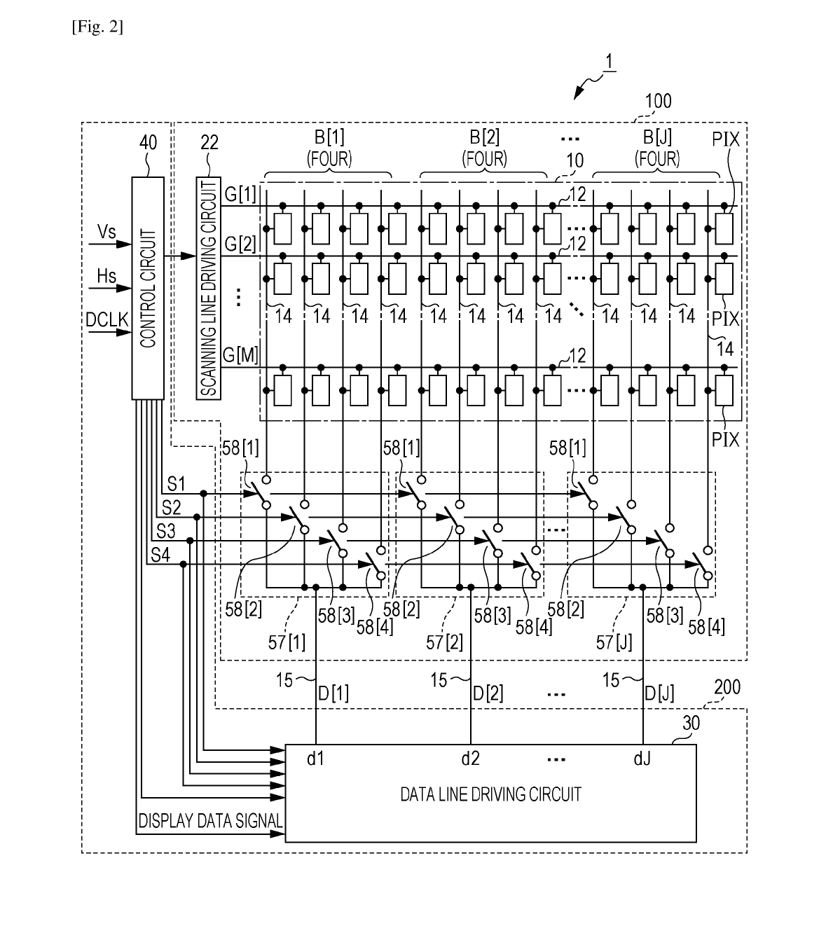

FIG. 2 is a block diagram which illustrates configurations of the electro-optical panel 100, and the driving integrated circuit 200. As illustrated in FIG. 2, the electro-optical panel 100 includes a pixel unit 10, a scanning line driving circuit 22 as a scanning line driving unit, and J demultiplexers 57[1] to 57[J] as a signal line selection unit. The driving integrated circuit 200 includes a data line driving circuit 30 as a signal line driving unit, and a control circuit 40 as a control unit.

The pixel unit 10 is formed of M scanning lines 12 and N signal lines 14 which are intersecting each other (M and N are natural numbers). A plurality of pixel circuits PIX are provided by corresponding to intersections of each scanning line 12 and each signal line 14, and are arranged in a matrix of vertical M rows x horizontal N columns.

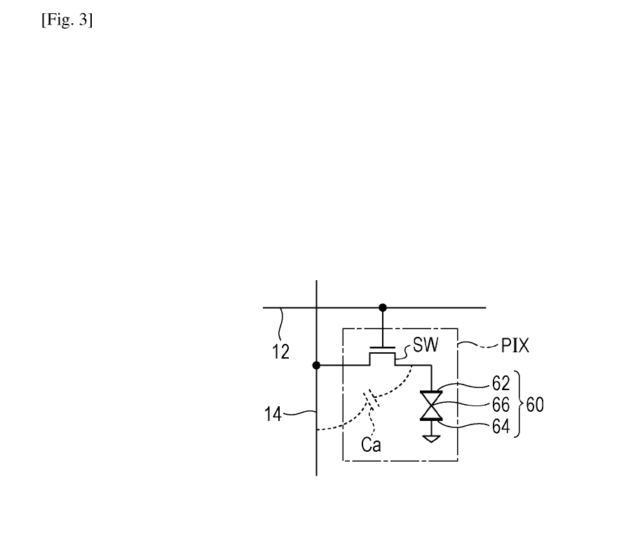

FIG. 3 is a circuit diagram of each pixel circuit PIX. As illustrated in FIG. 3, each pixel circuit PIX includes a liquid crystal element 60 and a switching element SW such as a TFT. The liquid crystal element 60 is an electro-optical element which is configured of a pixel electrode 62 and a common electrode 64 which are facing each other, and a liquid crystal 66 therebetween. Transmittivity (display grayscale) of the liquid crystal 66 is changed according to an applied voltage between the pixel electrode 62 and the common electrode 64. In addition, a configuration in which an auxiliary capacitor is connected to the liquid crystal element 60 in parallel can also be adopted. The switching element SW is configured of, for example, an N-channel transistor of which a gate is connected to the scanning line 12, is provided between the liquid crystal element 60 and the signal line 14, and controls an electrical connection therebetween (conduction/insulation). When a scanning signal Y[m] is set to a selection potential, a switching element SW in each pixel circuit PIX on the mth row transits to an ON state simultaneously.

When a scanning line 12 corresponding to a pixel circuit PIX is selected, and a switching element SW of the pixel circuit PIX is controlled to enter the ON state, a voltage corresponding to an image signal D[n] which is supplied to the pixel circuit PIX is applied to the liquid crystal element 60 of the pixel circuit PIX from the signal line 14, and a liquid crystal 66 of the pixel circuit PIX is set so as to have transmittivity corresponding to the image signal D[n]. In addition, when a light source (not illustrated) enters an ON (lighting) state, and light is emitted from the light source, the light penetrates the liquid crystal 66 of the liquid crystal element 60 which is included in the pixel circuit PIX, and proceeds to a viewer side. That is, when a voltage corresponding to the image signal D[n] is applied to the liquid crystal element 60, and the light source enters the ON state, the pixel corresponding to the pixel circuit PIX displays a grayscale corresponding to the image signal D[n].

When the switching element SW enters the OFF state, after the voltage corresponding to the image signal D[n] is applied to the liquid crystal element 60 of the pixel circuit PIX, ideally, an applied voltage corresponding to the image signal D[n] is maintained. Accordingly, ideally, each pixel displays a grayscale corresponding to the image signal D[n] in a period between the ON state and the subsequent ON state of the switching element SW.

As illustrated in FIG. 3, a capacitance Ca is parasitic on the signal line 14 and the pixel electrode 62 therebetween (or between signal line 14 and wiring which electrically connects pixel electrode 62 and switching element SW). For this reason, there is a case in which a potential fluctuation of the signal line 14 is propagated to the pixel electrode 62 through the capacitance Ca, and the applied voltage of the liquid crystal element 60 fluctuates while the switching element SW is OFF state.

In addition, a common voltage LCCOM which is a constant voltage is supplied to the common electrode 64 through a common line (not illustrated). As the common voltage LCCOM, a voltage of approximately −0.5 V is used when setting a center voltage of the image signal D[n] to 0 V. The voltage value is determined depending on a property such as the switching element SW.

According to the embodiment, in order to prevent so-called a burn-in, a polarity inversion driving in which a polarity of a voltage which is applied to the liquid crystal element 60 is inversed at a predetermined period is adopted. In the example, a level of the image signal D[n] which is supplied to the pixel circuit PIX through the signal line 14 is inversed in each unit period with respect to a center voltage of the image signal D[n]. The unit period is a period of one unit of an operation in which the pixel circuit PIX is driven. In the example, the unit period is set to a vertical scanning period. However, the unit period can be arbitrarily set, and for example, may be times of a natural number of the vertical scanning period. According to the embodiment, a case in which the image signal D[n] becomes a high voltage with respect to the center voltage of the image signal D[n] is set to a positive polarity, and a case in which the image signal D[n] becomes a low voltage with respect to the center voltage of the image signal D[n] is set to a negative polarity.

Returning to descriptions in FIG. 2, the control circuit 40 synchronously controls the scanning line driving circuit 22 and the data line driving circuit 30 based on an external signal such as a vertical synchronization signal Vs, a horizontal synchronization signal Hs, a dot clock signal DCLK, or the like, which is input from an external device (not illustrated). The scanning line driving circuit 22 and the data line driving circuit 30 control a display of the pixel unit 10 by mutually cooperating, under the synchronous control.

The scanning line driving circuit 22 outputs scanning signals G[1] to G[M] to each of M scanning lines 12. The scanning line driving circuit 22 sequentially sets the scanning signals G[1] to G[M] with respect to each scanning line 12 to active levels by one horizontal scanning period H according to an output of a horizontal synchronization signal Hs from the control circuit 40.

Here, in a period in which the scanning signal G[M] corresponding to the mth row is in the active level, and a scanning line corresponding to the row is selected, each switching element SW of N pixel circuits PIX of the mth row enters the ON state, and each of the N signal lines 14 is connected to each pixel electrode 62 of the N pixel circuits PIX of the mth row through each of the switching elements SW.

The N signal lines 14 in the pixel unit 10 are divided into J wiring blocks B[1] to B[J] by setting four signal lines which are neighboring to be a unit (J=N/4). Each of the demultiplexers 57[1] to 57[J] corresponds to the J wiring blocks B[1] to B[J].

Each of the demultiplexers 57[j] (j=1 to J) is configured of four switches 58[1] to 58[4]. In each of the demultiplexers 57[j] (j=l to J), a contact point on one side of each of the four switches 58[1] to 58[4] is commonly connected. In addition, each of the common connection points of the contact point on one side of the four switches 58[1] to 58[4] of each of the demultiplexers 57[j] (j=1 to J) is respectively connected to the J signal lines 15. The J signal lines 15 are connected to the data line driving circuit 30 of the driving integrated circuit 200 through the flexible circuit board 300. In addition, in each of the demultiplexers 57[j] (j=1 to J), each contact point on the other side of the four switches 58[1] to 58[4] is connected to the four signal lines 14 which configure the wiring block B[j] corresponding to the demultiplexers 57[j].

The ON/OFF of four switches 58[1] to 58[4] of each of demultiplexers 57[j] (j=1 to J) is respectively switched by four selection signals S1 to S4. The four selection signals S1 to S4 are supplied from the control circuit 40 of the driving integrated circuit 200 through the flexible circuit board 300. Here, when one selection signal S1 is at the active level, and the other three selection signals S2 to S4 are at a non-active level, only the switch 58[1] of J switches which respectively belong to the demultiplexers 57[j] (j=1 to J) enters the ON state. Accordingly, each of the demultiplexers 57[j] (j=1 to J) respectively outputs the image signals D[1] to D[J] on the J signal lines 15 to the first signal line 14 of each of wiring blocks B[1] to B[J]. Hereinafter, similarly, the image signals D[1] to D[J] on the J signal lines 15 are respectively output to the second, third, and fourth signal line 14 of each of the wiring blocks B[1] to B[J].

The control circuit 40 has a frame memory, includes at least a memory space of M×N bits corresponding to resolution of the pixel unit 10, and stores and maintains display data which is input from an external device in a frame unit. Here, the display data which defines the grayscale of the pixel unit 10 is data of 64 grayscales which is configured of 6 bits, as an example. The display data which is read from the frame memory is transferred to the data line driving circuit 30 serially as the display data through a bus of 6 bits. In addition, a precharge signal which will be described later is also included in the display data.

In addition, the control circuit 40 may also have a configuration in which a line memory of at least one line is included. In this case, the display data is transferred to each pixel by accumulating display data of one line in the line memory.

The data line driving circuit 30 outputs data to be supplied in each pixel row which is a writing target of data to the signal line 14 in cooperation with the scanning line driving circuit 22. The data line driving circuit 30 generates latch signals based on the selection signals S1 to S4 which are output from the control circuit 40, and sequentially latches display data signals of 6 bits of N which are supplied as serial data. The display data signals are made into a group of four pixels as time sequential data. In addition, the data line driving circuit 30 is provided with a digital to analog (D/A) conversion circuit, performs D/A conversion with respect to the digital data group, and generates a voltage as analog data. In this manner, the precharge signal is converted into a predetermined precharge voltage Vpre, and also a display data signal which is a time sequential signal in unit of 4 pixels is converted into a predetermined data voltage. In addition, a set of the precharge voltage and a data voltage of four pixels is supplied to each of the signal lines 15 in this order.

The electrical connection of each of switches 58[1] to 58[4] of the demultiplexers 57[j] (j=l to J) is controlled by the selection signals S1 to S4 which are output from the control circuit 40, and the switches enter the ON state at predetermined timing. In this manner, in 1H, the set of the precharge voltage and the data voltage of four pixels which is supplied to each signal line 15 is time sequentially output to the signal line 14 using the switches 58[1] to 58[4].

Hitherto is the configuration of the electro-optical device 1.

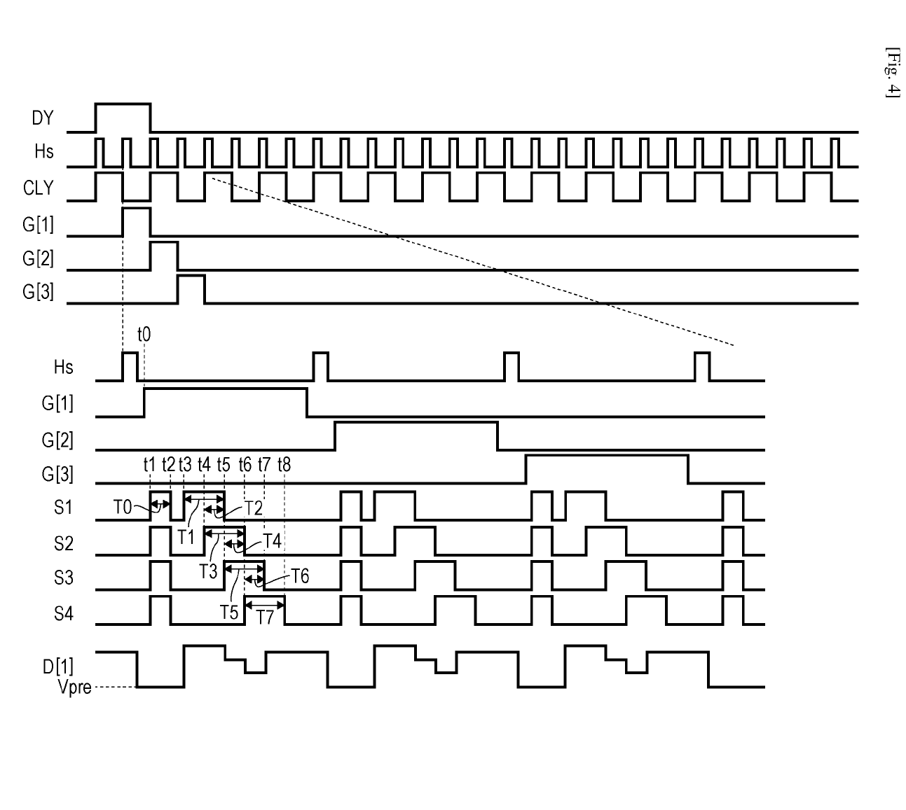

FIG. 4 illustrates a timing chart of the driving integrated circuit 200. When the horizontal synchronization signal Hs is input to the control circuit 40 from an external device, the control circuit 40 drives the scanning line driving circuit 22 in synchronization with the horizontal synchronization signal Hs. The scanning line driving circuit 22 generates scanning signals G[1], G[2], . . . , G[n] by performing the sequential shift with respect to signals corresponding to a Y transfer start pulse DY of one frame (1F) cycle according to a Y clock signal CLY. The scanning signals G[1], G[2], . . . , G[n] become sequentially active in each horizontal scanning period (1H). The data line driving circuit 30 generates sampling pulses SP1, SP2, . . . , SPz (not illustrated) based on an X transfer start pulse DX (not illustrated) of a horizontal scanning cycle, and an X clock signal CLX (not illustrated). In addition, the data line driving circuit 30 generates the image signals D[1] to D[j] by performing sampling with respect to image signals VID1 to VIDj (not illustrated) using the sampling pulses SP1, SP2, . . . , SPz (not illustrated).

The control circuit 40 outputs the selection signals S1 to S4 to the data line driving circuit 30 and the four switches 58[1] to 58[4] of the demultiplexers 57[j] (j=1 to J) in synchronization with the horizontal synchronization signal Hs. The data line driving circuit 30 outputs the image signals D[1] to D[j] from output terminals d1 to dj to the signal lines 15. The four switches 58[1] to 58[4] of the demultiplexers 57[j] (j=1 to J) enter the ON/OFF state based on the selection signals S1 to S4, and the image signals D[1] to D[j] which include the precharge signals are respectively output to the signal lines 14.

The control circuit 40 makes the selection signals S1 to S4 active at the same time, in timing t1 after a predetermined time from timing t0 at which the scanning signal G[1] becomes active, and maintains the active state of the selection signals S1 to S4 over a period T0. At this time, since the image signals D[1] to D[j] are set to the precharge voltage Vpre, the precharge voltage Vpre is written in the signal line 14 and the pixel.

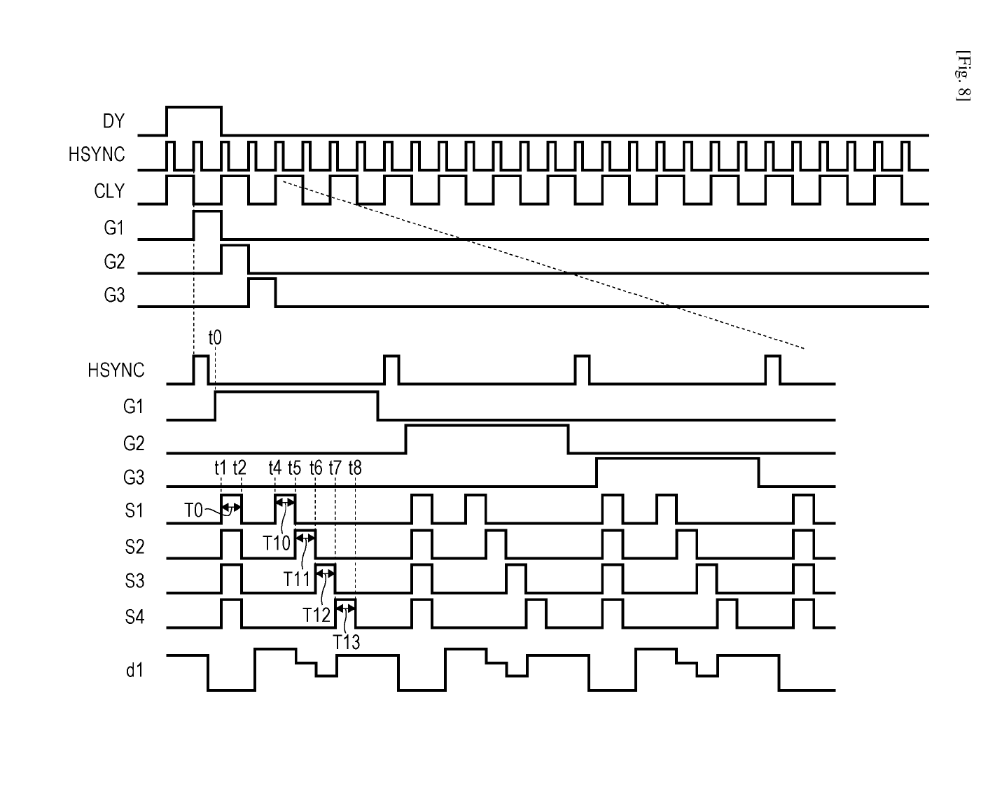

The control circuit 40 makes the selection signal S1 active in timing t3 after a predetermined time, after making the selection signals S1 to S4 non-active at timing t2. In the related art, as illustrated in FIG. 8, the selection signal S1 is made to be active at timing t4 which is later than the timing t3, however, according to the embodiment, the selection signal S1 is made to be active at the timing t3 which is earlier than the timing t4. As a result, a period in which the selection signal S1 becomes active is longer than a period T10 in the related art which is illustrated in FIG. 8, and becomes the period T1 as illustrated in FIG. 4.

Similarly, the control circuit 40 makes the selection signal S1 non-active at timing t5, however, the selection signal S2 is made to be active at the timing t4 which is earlier than the timing t5 by a predetermined time. In the related art, as illustrated in FIG. 8, the selection signal S2 is made to be active at the timing t5 which is later than the timing t4, however, according to the embodiment, the selection signal S2 is made to be active at the timing t4 which is earlier than the timing t5. As a result, a period in which the selection signal S2 becomes active is longer than a period T11 in the related art which is illustrated in FIG. 8, and the period becomes a period T3 as illustrated in FIG. 4. In addition, since the selection signals S1 and S2 are controlled in this manner, an overlapping period T2 in which both the selection signals S1 and S2 become active is generated.

Hereinafter, similarly, since the control circuit 40 makes the selection signal S3 active at the timing t5, a period in which the selection signal S3 becomes active is longer than a period T12 in the related art which is illustrated in FIG. 8, and the period becomes a period T5 as illustrated in FIG. 4. As a result, an overlapping period T4 in which both the selection signals S2 and S3 become active is generated. In addition, since the control circuit 40 makes the selection signal S4 active at timing t6, a period in which the selection signal S4 becomes active is longer than a period T13 in the related art which is illustrated in FIG. 8, and the period becomes a period T7 as illustrated in FIG. 4. As a result, an overlapping period T6 in which both the selection signals S3 and S4 become active is generated.

As described above, according to the embodiment, since the selection signal is driven so as to provide the overlapping period in which the plurality of signal lines 14 are selected at the same time, while making the period in which the signal line 14 is selected longer than that in the related art, it is possible to sufficiently secure the application time of the image signal with respect to the pixel without increasing the data line driving circuit, even when resolution of the electro-optical panel 100 is set to be high. As a result, it is possible to improve the image quality of the electro-optical panel 100. In particular, when a three-dimensional display (stereoscopic display) is performed in the electro-optical panel 100, an application time of a pixel voltage to a pixel corresponding to one signal line 14 becomes short, however, it is possible to perform a three-dimensional display with high image quality by applying the embodiment.

According to the embodiment, when two signal lines 14 are selected at the same time in each of wiring blocks B[1] to B[J] in the overlapping period, a pixel corresponding to a signal line 14 which is selected later in time is influenced by a pixel voltage which is written in a pixel corresponding to a signal line 14 which is selected earlier in time. However, for example, when contrast is high as the case in which a pixel voltage with the lowest luminance is applied to the pixel corresponding to the signal line 14 which is selected earlier in time, and a pixel voltage with the highest luminance is applied to the pixel corresponding to the signal line 14 which is selected later in time, it is difficult to recognize the influence with naked eyes. In addition, since the same pixel voltage is applied to the entire pixel when a pixel voltage with intermediate luminance is applied to the entire pixel, there is no influence which is described above. Instead, the image quality is improved since the application time of the pixel voltage with respect to the entire pixel becomes long.

### Second Embodiment

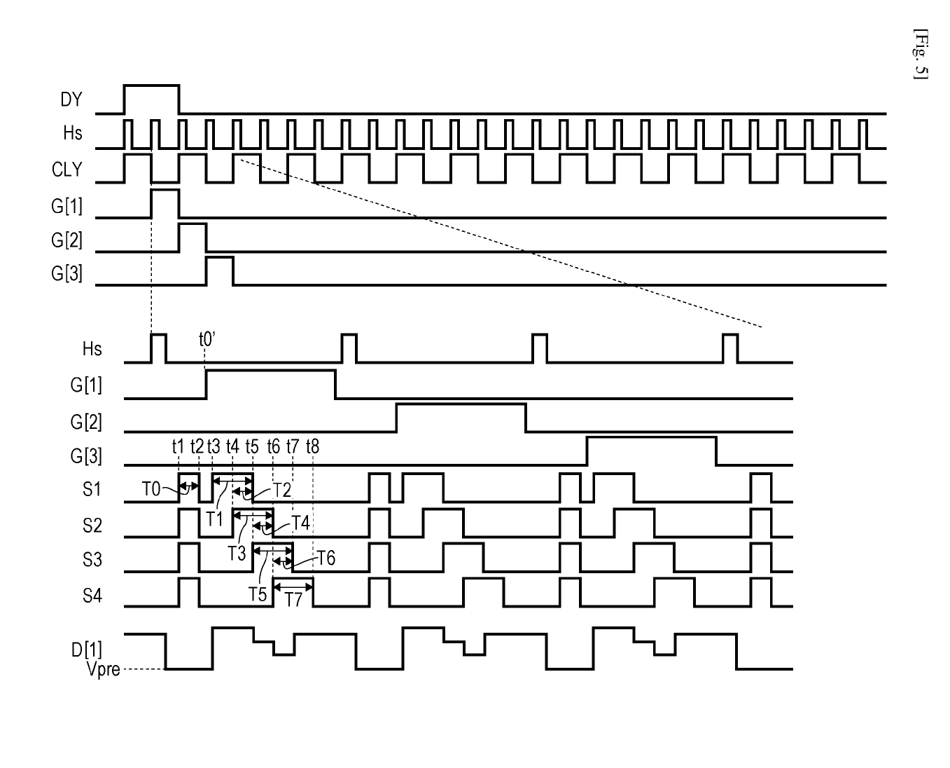

In the first embodiment, the example in which the scanning signals G[1], G[2], . . . , G[n] are made to be active at the timing t0 which is a little earlier than the timing t1 at which the precharge signal is applied has been described. However, according to the embodiment, as illustrated in FIG. 5, when applying the precharge signal, the scanning signals G[1], G[2], . . . , G[n] are made to be active at timing t0′ which is a little earlier than the timing t3 at which a firstly selected selection signal is made to be active, while making the scanning signals G[1], G[2], . . . , G[n] non-active.

The application of the precharge signal is performed in order to suppress display un-evenness which is influenced by a leak from a pixel transistor which is in the OFF state to the signal line 14, and as in the embodiment, it is possible to suppress the leak of the pixel transistor even in OFF states of the scanning signals G[1], G[2], . . . , G[n] at a time of applying the precharge signal.

Also in the embodiment, since the selection signal is driven so that a period in which the selection signals S1, S2, S3, and S4 are made to be active is set to be long compared to the related art, after making the scanning signals G[1], G[2], . . . , G[n] active at the timing t0′, and the overlapping period for selecting the plurality of signal lines 14 at the same time is provided, it is possible to sufficiently secure the application time of the pixel voltage with respect to the pixel without increasing the data line driving circuit even when resolution of the electro-optical panel 100 is set to be high, and as a result, it is possible to improve the image quality of the electro-optical panel 100.

### Third Embodiment

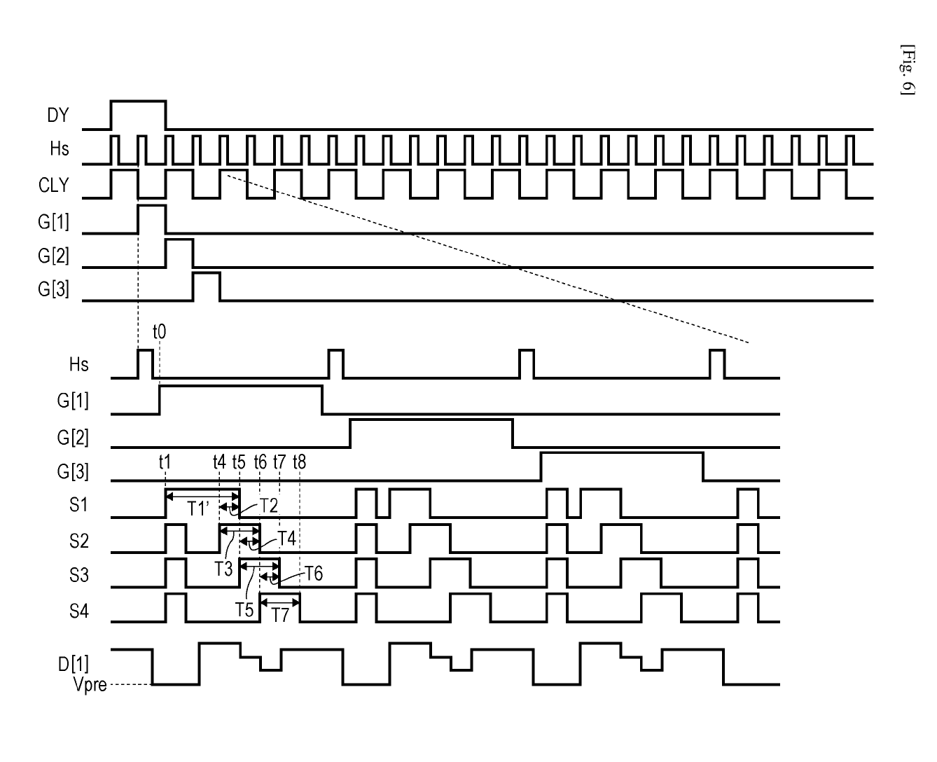

In the first embodiment, the example in which the selection signals S1, S2, S3, and S4 are made to be active at the timing t1 in order to apply the precharge signal, the selection signal S1 is made to be non-active once thereafter, and then the selection signal S1 is made to be active in order to apply the image signal at the timing t3 has been described. According to the embodiment, as illustrated in FIG. 6, the selection signals S1, S2, S3, and S4 are made to be active at the timing t1 in order to apply the precharge signal, the active state of the selection signal S1 is continued as is thereafter, and then the selection signal S1 is made to be non-active at the timing t5.

According to the embodiment, since the active state of the selection signal S1 is continued from starting of the application time of the precharge signal to ending of the selection of the selection signal S1 which is firstly selected, a period T1′ in which the selection signal S1 becomes active becomes longer than that in the first embodiment. As a result, it is possible to sufficiently secure the application time of the pixel voltage with respect to the pixel while reliably applying the precharge signal, and to improve the image quality of the electro-optical panel 100.

### Modification Example

The invention is not limited to each of the above described embodiments, and for example, it is possible to perform various modifications which will be described later. In addition, as a matter of course, each embodiment and each modification example may be appropriately combined.

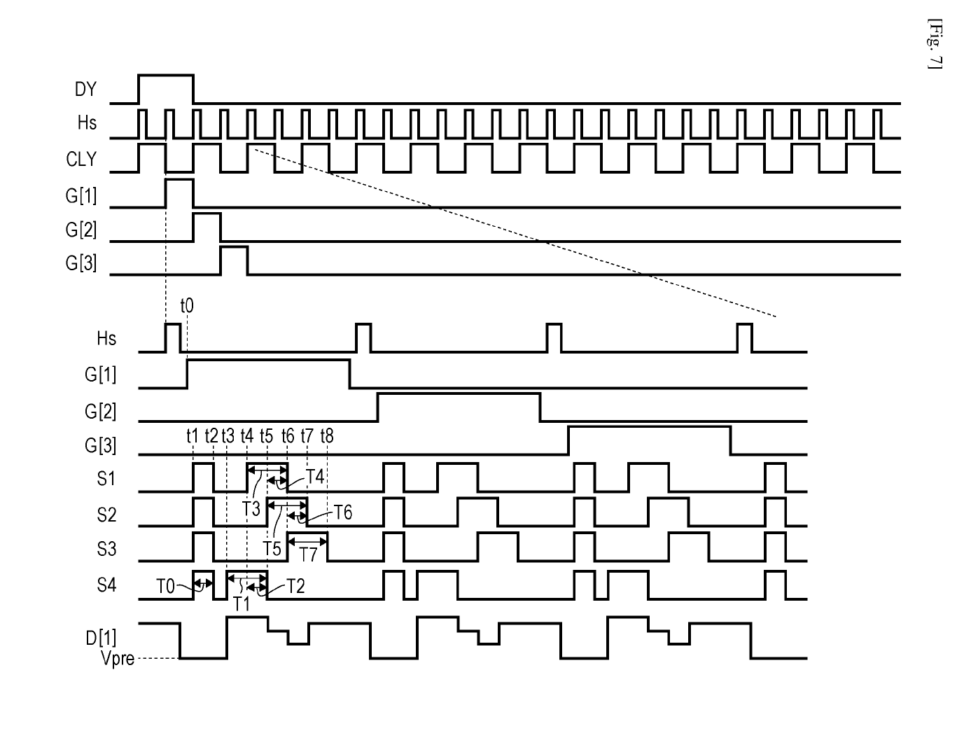

(1) In the above described each embodiment, the example in which the selection signal S1 is firstly made to be active, and then the selection signals S2, S3, and S4 are made to be active in this order has been described, however, the invention is not limited to such an example. For example, as illustrated in FIG. 7, the selection signal S4 is firstly made to be active, and then the selection signals S1, S2, and S3 may be made to be active in this order. In this case, an overlapping period of the selection signal S4 and the selection signal S1 is set to T2, an overlapping period of the selection signal S1 and the selection signal S2 is set to T4, and an overlapping period of the selection signal S2 and the selection signal S3 is set to T6. Even in this case, it is possible to drive the selection signal so that the overlapping period for selecting the plurality of signal lines 14 at the same time is provided, while making a period for selecting the signal line 14 longer than that in the related art. In addition, the order of making the selection signal active may be any order.

In addition, a configuration in which order of making the selection signal active is switched in every horizontal scanning period, or switched in every vertical scanning period may be adopted. In addition, a combination in which the order of making the selection signal active is also switched in every vertical scanning period, while switching the order in every horizontal scanning period may be adopted. The switching of the order for making the selection signal active may be the order of the selection signal S1, S2, S3, and S4 in the first horizontal scanning period, may be the order of the selection signal S2, S3, S4, and S1 in the second horizontal scanning period, may be the order of the selection signal S3, S4, S1, and S2 in the third horizontal scanning period, may be the order of the selection signal S4, S1, S2, and S3 in the fourth horizontal scanning period, and may be a repetition of these on or after the fifth horizontal scanning period.

(2) The example in which the N signal lines 14 are divided into J wiring blocks B[1] to B[J] by setting four signal lines which are neighboring to be a unit has been described, however, the block of the signal line may not be four signal lines which are neighboring, and may be two lines, three lines, five lines, six lines, seven lines, eight lines, . . . , and n lines (n is natural number).

(3) In the above described embodiments, a liquid crystal has been adopted as an example of the electro-optical material, however, the invention can be applied to an electro-optical device in which an electro-optical material other than the liquid crystal is used. As the electro-optical material, there is a material of which an optical property such as transmittivity or luminance is changed according to a supply of an electrical signal (current signal or voltage signal). For example, similarly to the embodiment, it is possible to apply the invention to various electro-optical devices such as a display panel using an organic electroluminescence (EL), an inorganic EL, or light emitting element such as light emitting polymer, an electrophoretic display panel in which a microcapsule containing colored liquid and white particles which are dispersed in the liquid is used as an electro-optical material, a twisting ball display panel in which twisting balls which are painted in different colors in each region of which a polarity is different from each other are used as an electro-optical material, a toner display panel in which black toner is used as an electro-optical material, or a plasma display panel in which high pressure gas such as helium or neon is used as an electro-optical material.

### Application Example

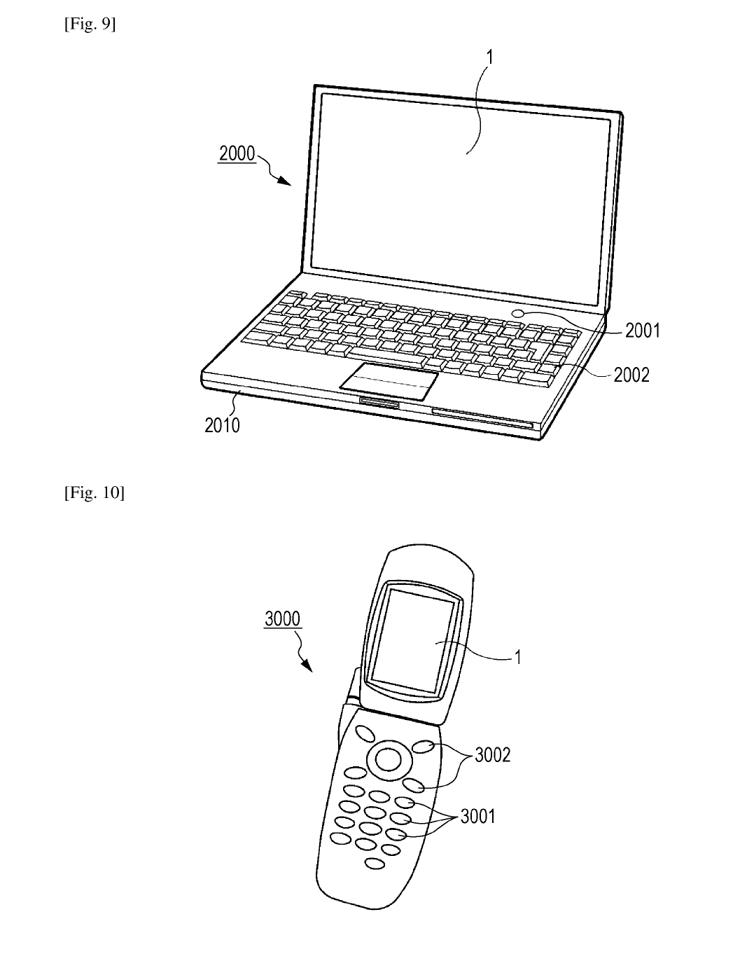

The invention can be used in various electronic apparatuses. FIGS. 9 to 11 exemplify specific forms of electronic apparatuses as an application target of the invention.

FIG. 9 is a perspective view of a portable personal computer in which an electro-optical device is adopted. A personal computer 2000 includes an electro-optical device 1 which displays various images, and a main body 2010 in which a power switch 2001, or a keyboard 2002 is provided.

FIG. 10 is a perspective view of a mobile phone. A mobile phone 3000 includes a plurality of operation buttons 3001, scroll buttons 3002, and an electro-optical device 1 which displays various images. A screen which is displayed on the electro-optical device 1 is scrolled when the scroll button 3002 is operated. The invention can also be applied to such a mobile phone.

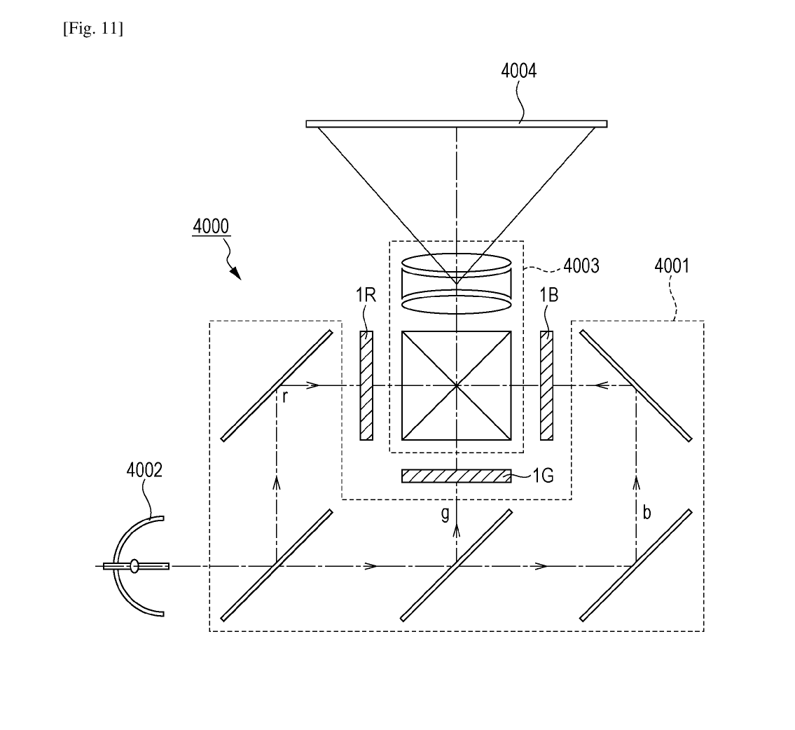

FIG. 11 is a schematic diagram which illustrates a configuration of a projection type display device (three plate type projector) 4000 in which an electro-optical device is adopted. The projection type display device 4000 includes three electro-optical devices 1 (1R, 1G, and 1B) which respectively correspond to display colors of R, G, and B which are different from each other. A lighting optical system 4001 supplies a red color component r to the electro-optical device 1R, supplies a green color component g to the electro-optical device 1G, and supplies a blue color component b to the electro-optical device 1B among emission light beams from a lighting device (light source) 4002. Each electro-optical device 1 functions as a light modulator (light bulb) which modulates each monochromatic light which is supplied from the lighting optical system 4001 according to a display image. A projection optical system 4003 projects emission light from each electro-optical device 1 to a projection surface 4004 by compositing the light. The invention can also be applied to such a liquid crystal projector.

In addition to the apparatuses exemplified in FIGS. 1, 9, and 10, as an electronic apparatus to which the invention can be applied, there is a mobile information terminal (Personal Digital Assistant (PDA)), a digital still camera, a television, a video camera, a car navigation device, a display for vehicle (instrument panel), an electronic organizer, electronic paper, a calculator, a word processor, a work station, a videophone, a POS terminal, a printer, a scanner, a copy machine, a video player, a device including a touch panel, or the like.

### REFERENCE SIGNS LIST

1 Electro-optical device

10 Pixel unit

12 Scanning unit

14 Signal line

15 Signal line

22 Scanning line driving circuit

30 Data line driving circuit

40 Control circuit

57 Demultiplexer

58 Switch

60 Liquid crystal element

62 Pixel electrode

64 Common electrode

66 Liquid crystal

100 Electro-optical panel

200 Driving integrated circuit

1. An electro-optical device comprising:
a plurality of scanning lines;
a plurality of signal lines;
a pixel which is provided so as to correspond to each intersection of the plurality of scanning lines and the plurality of signal lines;
a scanning line driving unit which supplies a scanning signal to a scanning line;
a signal line driving unit which supplies an image signal in which a data voltage with at least a size which corresponds to a grayscale to be displayed is subjected to time division multiplexing to the pixel through the signal line;
a signal line selection unit which selects the signal line which supplies the image signal according to a control signal; and
a control unit which selects another signal line while selecting one of the signal lines, and outputs the control signal so that an overlapping period occurs at a part of the selection period of the signal line, wherein the pixel includes a pixel electrode, a common electrode, a liquid crystal which is interposed between the pixel electrode and the common electrode, and a switching element which is provided between the pixel electrode and the signal line, and is controlled so as to be either an ON state or an OFF state based on a scanning signal which is supplied through the scanning line.

2. The electro-optical device according to claim 1, wherein the control unit outputs the control signal which selects the signal line at timing earlier than timing which is synchronized with an individual data voltage of the image signal which is subjected to time division multiplexing.

3. The electro-optical device according to claim 1 or 2, wherein the signal line driving unit supplies a precharge voltage to the signal line at least in a precharge period before supplying the data voltage to the pixel, and wherein the control unit outputs the control signal which selects all of the signal lines in the precharge period.

4. The electro-optical device according to claim 3, wherein the scanning line driving unit supplies the scanning signal which causes the switching element to be in the ON state to the scanning line in the precharge period.

5. The electro-optical device according to claim 3 or 4, wherein the signal line driving unit outputs the control signal which selects the signal line which is firstly selected, in the entire period of the precharge period and the selection period of the signal line which is firstly selected in one horizontal scanning period.

6. The electro-optical device according to any one of claims 1 to 5, wherein the signal line driving unit frequently changes selection order of the signal line using the control signal.

7. A control method of an electro-optical device which includes a plurality of scanning lines, a plurality of signal lines, a pixel which is provided so as to correspond to each intersection of the plurality of scanning lines and the plurality of signal lines, in which the pixel includes a pixel electrode, a common electrode, a liquid crystal which is interposed between the pixel electrode and the common electrode, and a switching element which is provided between the pixel electrode and the signal line, and is controlled so as to be in either an ON state or an OFF state based on a scanning signal which is supplied through the scanning line, the method comprising:
supplying the scanning signal to the scanning line;
supplying an image signal in which a data voltage with at least a size which corresponds to a grayscale to be displayed is subjected to time division multiplexing to the pixel through the signal line;
selecting the signal line which supplies the image signal according to a control signal;
selecting another signal line while selecting one of the signal lines; and
outputting the control signal so that an overlapping period occurs at a part of a selection period of the signal line.

8. An electronic apparatus comprising:
the electro-optical device according to any one of claims 1 to 6.
